(19) United States
(12) Patent Application Publication
(10) Pub. No.: US 2008/0040417 A1
(43) Pub. Date: Feb. 14, 2008

(54) SYSTEM AND METHOD FOR ALLOCATING WORKFLOW OPERATIONS TO A COMPUTING DEVICE

(75) Inventor: Robert M. Juncker, Farmington, MN (US)

Correspondence Address: HENSLEY KIM & HOLZER, LLC, 1660 LINCOLN STREET, SUITE 3000, DENVER, CO, 80264, US

(73) Assignee: Gearworks, Inc., Eagan, MN (US)

(21) Appl. No.: 11/833,131

(22) Filed: Aug. 2, 2007

Related U.S. Application Data
(60) Provisional application No. 60/821,868, filed on Aug. 9, 2006.

(51) Int. Cl. G06F 15/16

(52) U.S. Cl. 709/201

(57) ABSTRACT

A method includes determining capabilities associated with a first computing device and based on the capabilities of the first computing device, determining at least a subset of one or more operations in a workflow that the first device can perform. The method may involve transmitting to the first computing device at least the subset of the one or more operations, performing by the first computing device the subset of the one or more operations, and performing by a second computing device any remaining operations in the one or more operations not included in the subset. A system includes a central computer operable to receive capabilities identification information and use the capabilities identification information to determine capabilities associated with a remote computer, and further to determine a subset of one or more operations to be performed by the remote computer during performance of a workflow, based on the determined capabilities associated with the remote computer.

### CROSS REFERENCE TO RELATED APPLICATIONS

The present application claims the benefit of priority to U.S. Provisional Patent application Ser. No. 60/821,868, entitled “Split-Logic Determination”, and filed on Aug. 9, 2006, which is incorporated herein by reference for all purposes.

### TECHNICAL FIELD

Embodiments of the invention generally relate to systems and methods for determining operations to be allocated to a device based on a capabilities set of the device. More specifically, embodiments relate to systems and methods for splitting a set of workflow operations between a first device and a second device based at least in part on capabilities associated with the first device.

### BACKGROUND

A workflow is a set of activities performed by humans and/or computing devices to achieve one or more specified results. The activities are typically related to each other and triggered by events. With regard to the performance of activities by computing devices (e.g., automated activities or operations), the activities may be more or less complex. For example, a simple activity may simply involve reading data from a memory store and transmitting that data to a specified receiver. As a more complex example, a computer may need to facilitate ordering of products. This activity may call for first accessing a network-based server computer to order products from a supplier. In the latter example, the client computer may be required to display a complicated order form, collect user input through the form, execute scripts related to the form, and other processes. Because capabilities of computers vary, the ability to perform a given activity in a workflow may vary from one computer to another.

For example, with regard to the example above, in cases where the client computer is sufficiently powerful (e.g., substantial memory, processing power, viewable screen area, and input/output resources), the client computer will generally have no problems processing large amounts of information from the server, and/or carrying out complex processes. However, other client computing devices may be less powerful; e.g., they may not be Java script enabled or they may lack inadequate processor power or memory to perform complicated mathematical operations. Such less powerful computing devices are generally less capable of performing certain activities.

As the trend for smaller and smaller computing devices continues, at least in part to accommodate mobile computing, it is not uncommon for some mobile computing devices to be unable to perform workflow activities adequately. In particular, when small mobile devices access data from other devices, such as servers, the small devices often cannot adequately process or present the data. These situations can arise for numerous reasons, such as a device's inadequate user interface, small form factor, monochrome display, limited memory, or lack of application or development environment. For example, a typical consumer cellular telephone has no development environment, a small and insufficient keypad, and a very basic, monochrome display.

Of course, there are numerous different types of mobile devices that interact with network-based computers everyday to carry out activities in workflows. Each type of device typically has its own capabilities, ranging from very crude to very sophisticated. For example, black-boxes or black phones, which are often used by mobile workers in their vehicles, typically do not have displays, user interfaces, or development environments, while mobile laptop computers have very robust user interfaces, advanced development environments, and substantial processing power. In between these two extremes are numerous types of devices with different levels of capabilities, such as business-oriented cell phones, and business-oriented personal digital assistants (PDAs).

Traditional network-based server computers with which mobile devices interact, typically cannot provide a different application interface, or different data or applications to each type of device in order to accommodate that particular device's capabilities. As a result, less capable devices may have difficulty processing and presenting data from the server computer, while more advanced devices may have no problem doing so. This can give rise to very different computer/network experiences for different mobile workers. Those field workers with less powerful devices typically have a poor experience, in which workflow activities are not adequately completed, if at all; those with more powerful devices have a good experience, where the workflow activities are performed effectively and efficiently.

The adequacy (or inadequacy) of mobile computing devices to perform workflow activities is particularly apparent to field workers. Field workers, such as product delivery personnel, home/product repair workers, sales people, and home health care service providers, are mobile while on their jobs, traveling to various locations to perform their services. Field workforces are common in companies such as telecommunications, network service providers, and power companies, which deploy and maintain geographically dispersed field equipment (e.g., telecommunications/power lines, power substations), which must be maintained and serviced by field workers. In these industries, field workers typically use mobile devices of all types in the course of performing their jobs, for communication, and acquisition, entry, and processing of data while in the field. Unfortunately, many mobile devices provide inadequate data processing capabilities to field workers. In addition, the level of data processing capabilities may vary dramatically from one field worker's device to the next, which can adversely impact the efficiency, consistency or accuracy of services provided by such companies.

### SUMMARY

Embodiments of the invention include systems and methods for splitting (e.g., allocating) operations between a first device and a second device, based on capabilities of the first device. In some embodiments, the operations are part of performance of a workflow. During performance of the workflow, it is determined what operations the first device is capable of performing. The first device performs a determined set of operations that the first device is capable of performing, and the second device performs another set of operations that the first device is unable to perform, or unable to perform at a specified quality level. The set of operations to be performed by the first device is determined based on capabilities associated with the first device and an identified workflow to be facilitated with the use of the first device.

In some embodiments, the identified workflow is used to determine a set of workflow operations to be performed. Each operation to be performed is mapped to one or more capabilities to determine capabilities required by a computing device in order to perform the operations of the identified workflow. The capabilities set associated with the first device is analyzed with reference to the determined required capabilities to determine which, if any of the required capabilities are in the capabilities set associated with the first device. If any of the required capabilities are found in the capabilities set, the first device is notified of one or more operations in the workflow operations that the first device is to perform based on the analysis of the capabilities set with reference to the required capabilities.

An embodiment of a method for allocating operations between a first device and a second device includes receiving by the second device a workflow identifier identifying a workflow to be facilitated by the first device. The method further includes determining operations included in the identified workflow and mapping the determined operations to capabilities required to perform the operations. The method further includes determining which of the required capabilities are included in the capabilities set, The first device may be a mobile communication device. The second device may be a server computer.

The method may further include the second device notifying the first device of a set of one or more of the workflow operations that the first device is to perform. Notifying the first device may involve sending identifiers of, or references to, the one or more operations to the first device. Alternatively or in addition, the notifying may involve sending one or more bookmarks that reference positions in a list of workflow operations. Based on the operations that the first device is notified of, and/or the bookmarks, operation performance may be handed back and forth between the first device and the second device one or more times. In addition workflow operations may be performed by the first and second device in parallel.

Another embodiment of a method for performing a workflow includes establishing a connection to a second device by a first device, sending first device capabilities information to the second device, wherein the information identifies capabilities of the first device, and, based on the capabilities information, determining at least a portion of the workflow operations that the first device is capable of performing. The method may further include the first device carrying out at least one operation in the workflow and the second device carrying out at least one operation in the workflow.

An embodiment of a system for facilitating carrying out a workflow by a worker includes a first computing device used by, and providing a user interface to, the worker, wherein the first computing device is operable to communicate via a network, a second computing device in operable communication with the first computing device via the network, and memory accessible by the second computing device, wherein the memory has stored thereon capabilities data indicating capabilities of a plurality of types of computing devices, and wherein the second computing device is operable to receive a device type identifier identifying the first computing device, determine capabilities of the first computing device based on the device type identifier, identify operations in the workflow that the first device cannot perform based on the capabilities, and perform the operations that the first device cannot perform during performance of the workflow.

An embodiment of a method for performing a workflow using a first computing device in communication with a second computing device includes determining capabilities associated with a first computing device and based on the capabilities of the first computing device, determining at least a subset of the one or more operations that the first device can perform. The method may involve transmitting to the first computing device at least the subset of the one or more operations that the first device can perform, performing by the first computing device the subset of the one or more operations, and performing by a second computing device any remaining operations in the one or more operations not included in the subset.

An embodiment of the method may further include transmitting the capabilities associated with the first computing device to the second computing device. Transmitting the capabilities associated with the first computing device may involve transmitting the capabilities when the first device powers on. Determining at least a subset of the one or more operations that the first device can perform may be performed by the second computing device. The subset of operations that the first device can perform may include at least one complete action from one or more actions in the workflow.

An embodiment of the method may involve transmitting more operations than are included in the determined subset of operations, and may further include transmitting a split-logic indicator indicating which operations the first computing device is to perform and which operations the second computing device is to perform. Determining capabilities associated with the first computing device may involve determining the device capabilities based on a device type associated with the first computing device. The method may further include registering the first computing device with a device registration server, wherein registering the first computing device includes registering the device type, and wherein determining capabilities associated with the first computing device further includes reading the device type from the device registration server, and reading capabilities of the first computing device from a memory storing a plurality of device types, each device type stored in association with device capabilities. Still further the method may involve transmitting the device type from the first computing device to the second computing device.

An embodiment of the method includes defaulting to a minimal set of device capabilities when determining capabilities of a first device. Transmitting at least the subset of operations that the first computing device can perform may include transmitting only the subset of operations that the first computing device can perform. The method may further include performing by the first computing device the subset of operations transmitted to the first computing device, notifying the second computing device that the first computing device has completed performing the subset of operations, and performing by the second computing device one or more remaining operations in the workflow that are not included in the subset of operations that the first computing device performed.

An embodiment of a system includes a central computer operable to receive capabilities identification information and use the capabilities identification information to determine capabilities associated with a remote computer, and further to determine a subset of one or more operations to be performed by the remote computer during performance of a workflow, based on the determined capabilities associated with the remote computer. The central server is further operable to perform remaining operations of the workflow not included in the subset.

An embodiment of the system may further include a data store in operable communication with the central computer. The data store stores, in part, capabilities information related to a plurality of remote computers, wherein the central computer is further operable to look up capabilities associated with the remote computer. The capabilities information in the data store may include a device matrix searchable by one or more of a device type or a device identifier. The data store may further store device registration data related to a plurality of remote computers, and the remote device may be operable to register with the data store.

In one embodiment of a system, a central computer includes a split-logic determination module operable to map operations to remote device capabilities that are required to perform the operations and a communication interface operable to transmit to the remote computer at least the subset of operations to be performed by the remote computer. The communication interface may or may not transmit only the subset of operations to the remote computer, and the remote computer may further be operable to notify the central computer when the remote computer is completed performing the subset of operations. Further still, the split-logic determination module may be operable to generate a split-logic indicator indicating a logical point in the one or more operations of the workflow that divides the subset of operations to be performed by the remote computer from another subset of operations to be performed by the central computer, and the communication interface may be operable to transmit all of the one or more operations in the workflow to the remote computer.

In yet another embodiment the remote computer is operable to notify the central computer when the remote computer has completed performing the subset of operations up to the split-logic indicator. The central computer may be further operation to associate a minimal set of capabilities with the remote device.

### BRIEF DESCRIPTION OF THE DRAWINGS

FIG. 1 illustrates an exemplary operating environment including exemplary mobile devices communicating via a network(s) with a server that is configured to determine and perform operations that the mobile devices are incapable of performing during workflows in accordance with one embodiment.

FIG. 2 illustrates an exemplary data processing system, including functional modules for carrying out split-logic determination in accordance with one embodiment.

FIG. 3 illustrates an exemplary system using capabilities information associated with a mobile computing device to carry out split-logic determination in accordance with one embodiment.

FIG. 4 is a flowchart illustrating a process of performing a split-logic determination in accordance with one embodiment.

FIG. 5 is a flowchart illustrating an algorithm for use in performing split-logic determination in accordance with one embodiment.

FIG. 6 is a schematic diagram of a computing device upon which embodiments of the present invention may be implemented and carried out.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Embodiments of the invention include systems and methods for splitting (e.g., allocating) a set of one or more operations between a first device and a second device, based on capabilities of the first device. In some embodiments, the operations are included in a workflow. During performance of the workflow, it is determined what portions of the set of operations the first device is capable of performing. The first device performs one or more operations in a workflow that the first device is capable of performing, and the second device performs one or more operations in the workflow that the first device is not capable of performing.

Although embodiments described herein relate to field workers performing workflows in a mobile service provider environment, it is to be understood that the invention is not limited to such an environment. Other embodiments may relate to an organizational environment in which workers do not work in the field. For example, some embodiments may related to a banking environment, in which a mortgage broker works in an office at a desktop computer that accesses a server to perform data processing related to financing. As another example, other embodiments may relate to a medical environment in which a doctor uses image processing to analyze medical images, in which a local computer is capable of performing some of the analysis, and a remote computer performs the analysis that the local computer is incapable of performing.

Furthermore, although embodiments are described herein in terms of a “client/server” relationship between computing devices, it is to be understood that the invention is not limited to client/server relationships. For example, concepts described herein may be applied to peer-to-peer environments, content distribution networks, and others. In fact, even in a “client/server” environment, the so-called client computer can act as a server in some contexts, while the so-called server computer can act as a client in some contexts. The embodiments described herein are merely to enable one of skill in the art to make and use the invention, and are not intended to limit the scope of the invention which is set forth in the claims shown below.

Prior to describing one or more preferred embodiments of the present invention, definitions of some terms used throughout the description are presented.

### Definitions

The term “carrier” refers broadly to any type of telecommunications carrier. A carrier typically maintains a network, such as a wireless or cellular network, over which mobile service providers, and others can communicate and/or access a data server employing split-logic determination. Carriers can also provide services (e.g., applications) on their network. By way of example, but not limitation, Nextel®, Verizon®, and Sprint® are telecom carriers.

The term “customer” includes mobile service provider companies who dispatch mobile service providers to field locations to provide services. Such mobile service providers typically have wireless mobile communication devices, through which they may communicate with servers employing split-logic determination functionality as well as applications and data associated with mobile services. By way of example, but not limitation, lawn maintenance companies, food and drink distributors, product delivery companies, and companies that use field technicians, may be customers by virtue of services that they provide “in the field”.

The term “module” refers broadly to a software, hardware, or firmware (or any combination thereof) component. Modules are typically functional components that can generate useful data or other output using specified input(s). An application program (also called an “application”) may include one or more modules, or a module can include one or more application programs.

The term “operation” refers to one or more computer-executable steps that is/are performed or facilitated by a computing device. An operation may be made up of, or reference, one or more computer-executable instructions. For example, an operation may consist of the execution of an application program or a portion of an application program.

The term “data processing” is one type of operation and refers generally to any type of data manipulation, such as, but not limited to, the entering, storing, updating, combining, associating, presenting and/or retrieving of data. In general, the degree to which a particular type of computing device can perform data processing depends upon the computing device's capabilities.

A “workflow” is made up of a series of “operations.” Operations in the workflow are typically carried out, or facilitated by, one or more computing device. A workflow may also include or specify actions, events, rules, and other data necessary to carry out the workflow. For example, an event may trigger an action which consists of a number of operations. As an example, an electrical field technician may be assigned a workflow that involves fixing a transformer that has been blown out by lightening. The workflow may also include identifying whether the transformer needs to be replaced, or whether it can be repaired. If it can be repaired, another set of events and actions will be followed, but if the transformer cannot be repaired, another different set of events and actions will be followed to replace the transformer. During workflows, computing devices typically provide data processing operations to facilitate the worker in performing actions of the workflow.

The term “computing device” refers generally to any device that can perform at least one function, including communicating with another computing device.

The term “device capability” generally refers to a computing device's ability to perform an action, in a certain way, or at a certain level (e.g., quality level). Device capabilities may be identified by, or determined from, the device's type, specifications, settings, or components. For example, a device may have 1 Gigabyte (Gb) of random access memory (RAM), which means the device can store up to 1 Gb of data in RAM. As another example, a device may have 16 bits per pixel, which indicates the color depth that the device is capable of displaying. As discussed with reference to various embodiments, device capabilities can be used to determine the extent to which the device can perform data processing.

### Exemplary System

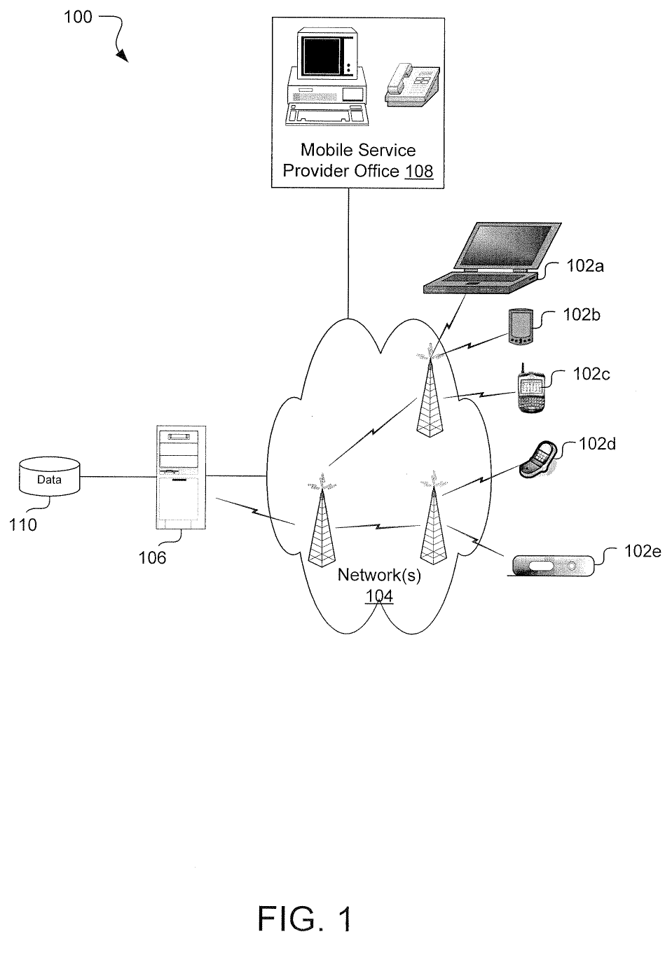

FIG. 1 illustrates an exemplary operating environment 100 in accordance with one embodiment. The operating environment 100 includes one or more exemplary mobile computing devices 102 operable to communicate via a network 104 with a server computer 106. In this embodiment, the mobile computing devices 102 generally act as client devices. In some embodiments, mobile computing devices 102 are used by a mobile workforce. As such, mobile computing devices 102 are typically relatively small so that they are easily portable by mobile workers, such as plumbers, electricians, field technicians, delivery personnel, home medical providers, and others.

Also shown in FIG. 1 is a mobile service provider office 108 of a mobile service provider company. The mobile service provider company is generally affiliated in some way with one or more field workers who use the mobile computing devices 102. For example, mobile field workers may be contractors or employees of the mobile service provider company. Field workers may be dispatched by the mobile service provider office 108, and may generally keep in communication with the mobile service provider office 108 throughout the work day. The mobile service provider office 108 also communicates with the server 106 for various purposes, including provisioning (e.g., deploying, uploading, configuring, or updating) of applications and data onto the server 108. As discussed in further detail below, the applications and data on the server 108 are accessible by the mobile computing devices 102.

Examples of mobile computing devices 102 include, without limitation, mobile or rugged laptop computers 102a, business-oriented personal digital assistants (PDA) 102b, and cellular telephones, which can range from powerful business-oriented devices, such as a Blackberry® 102c, to basic consumer-oriented cell phones 102d. Mobile computing devices 102 also include vehicle-mounted “black boxes” 102e. A black box 102e is a device that is typically installed in a vehicle and generally does not include a user interface. The black box 102e has embedded intelligence that allows the black box 102e to capture and communicate vehicle diagnostic information and GPS positioning information.

Each of the exemplary types of computing devices 102, and other types of computing devices that are not shown, have different capabilities. In terms of the exemplary devices 102 shown in FIG. 1, at the top of the capabilities hierarchy is the mobile laptop computer 102a, which typically has a flexible, sophisticated application and development environment, which is tailored for developers. The laptop 102a has great processing power and a very large amount of memory for storage. By contrast, at the bottom of the capabilities hierarchy is the black box 102e, which typically has only basic communication abilities and does not have a display or other user interface that would enable user interaction with the black box 102e. In between the laptop computer 102a and the black box 102e in the capabilities hierarchy are the business-oriented PDAs 102b, the business-oriented cell phones (e.g., Blackberry™ 102c), and the consumer-oriented cell phones 102d.

Business-oriented cell phones typically provide a basic development environment and a virtual machine for running applications; however, a business-oriented cell phone typically has only limited processing power and limited memory for storing information. By contrast, consumer-oriented cell phones 102d typically have no development environment, a very limited user interface, a small form factor and/or a small, monochrome display. In terms of capabilities, business-oriented PDAs 102b typically have more capabilities than all the other exemplary mobile devices 102, except for the laptop computer 102a. A business-oriented PDA 102b typically has an operating system (e.g., Windows™, Linux) that supports a robust application environment with good processing power and a fair amount of memory.

Depending on the capabilities of a mobile computing device 102, the device 102 generally performs or facilitates performance of one or more operations that are part of a workflow. The operation(s) may include, for example, processing one or more types of data. Exemplary types of data, include, but are not limited to, audio, graphics, numerical, and application-specific data. The degree to which each type of device 102 can perform operations such as data processing depends, at least in part, on the capabilities of that type of device 102. Thus, for example, the PDA 102b is generally capable of performing relatively complex mathematical processing of numerical data, by virtue of the PDA's 102b processing power and memory. However, the black box 102e typically cannot perform complex numerical processing, but rather is generally designed for a much more limited purpose, such as capturing GPS position data and communicating that data out to a receiver.

In addition to the capabilities listed above, by way of further example, one or more of the mobile computing devices 102 can be GPS-enabled, provide wireless communication, dual-tone multi-frequency (DTMF), and/or push-to-talk (PTT) functionality, which facilitate communication over the network 104. For example, a mobile communication device 102 may be operable to dial a telephone number to thereby connect to the server 106 or the mobile service provider office 108.

In general, the network 104 provides a communication channel between the server 106 and communication devices 102. The network 104 typically includes multiple interconnected subnetworks. The subnetworks may be wired or wireless, or any combination thereof. The subnetworks may be circuit-switched, packet-switched or any combination thereof. Thus, by way of example, but not limitation, the network 104 may include any combination of the Internet, a voice over Internet protocol (VoIP) network, third generation (3G) data networks, public switched telephone network (PSTN), an intranet, a local area network (LAN), and/or a wide area network (WAN), or one or more logical portions of those networks. The network 104 may include a virtual private network. The sub networks are typically deployed and maintained by telecommunication carriers, backbone network providers, voice over IP (VoIP) network service providers, and others, and may carry data/signals in numerous different formats and protocols.

In the illustrated embodiment, a memory, such as a database 110, is coupled to the server 106. The database 110 may include, in part, capability information about different types of computing devices. In some embodiments, the capability information logically associates device types with capabilities. The server 106 can identify the capabilities of a computing device (e.g., a client device), based on the type of computing device, by looking up the device type in the database 110, and reading the capabilities associated with the type of computing device. The database 110 may also include workflow data related to workflows that the field workers perform. Workflow data includes operations associated with each workflow. Each workflow may be identified by a workflow identifier.

Mobile service provider companies, referred to as customers in this context, can define workflows associated with their workforces. These workflow definitions can be deployed from the service provider office 108, and stored as workflow data in the database 110, or they can be used to generate the workflow data in the database 110. The workflow definitions from the customers may or may not be tailored to the particular types of devices that the field workers use. The customers may not be aware of, or be able to track, all the different types of mobile devices 102 used by their field workers. As such, it is possible that workflows that are deployed include operations that cannot be carried out or facilitated by one or more of the computing devices 102, or that cannot be carried out or facilitated by one or more of the computing devices 102 to a specified level (e.g., quality or efficiency).

Advantageously, the server 106 includes functionality to determine operations that can be performed, or facilitated, by the computing devices 102. Further, the server 106 is configured to allocate operations to the computing devices 102 that the computing devices 102 are determined to be capable of performing or facilitating. The process of determining the operations that the computing devices 102 can perform or facilitate and allocating those operations is referred to as a split-logic determination process. In some embodiments the server 106 performs split-logic determination on a workflow by workflow basis and on a computing device by computing device basis. For example, the server 106 can determine, based on a given workflow and based on a given computing device (or type of computing device), which operations in the workflow can be carried out or facilitated by the given computing device. Further, operations that are not allocated to the given computing device can in some cases be carried out or facilitated by the server 106 in order to complete the workflow.

With more specific regard to mobile service provider office 108 and field workers, as discussed above, the mobile service provider office 108 can provide applications and data at the server 106 and the database 110, which may be accessed and used by the field workers while working remotely in the field. Field workers generally perform workflows, which involve performing specified tasks. Tasks are performed by carrying out operations. Operations may be event driven; e.g., operations may be performed in response to events. Alternatively or in addition, operations may be scheduled. Performance of operations may involve data processing on the part of the field worker's mobile computing device 102 and/or the server 106.

To illustrate, a field worker may access an application or data at the server 106 to facilitate, guide, or monitor performance of a workflow. By way of example, the field worker may use a product ordering application, or a billing application, or a timesheet application. At different steps in the workflow, these applications may perform operations such as data processing. The operation may be associated with, or in response to, an event. Real-time data processing may be required, based on the particular situation in the field, or a current event or action. For example, bill or time entry and analysis may require processing of billing data or timesheets data.

In some embodiments, the server 106 and/or the mobile computing device 102 is operable to analyze capabilities of the mobile computing device 102 to identify workflow operations that the mobile computing device 102 is capable of performing. In some cases, a mobile computing device 102 is considered to be capable of performing a specified operation if the computing device 102 can meet a specified performance level, such as being able to perform the data processing within a certain amount of time, or within a certain range of accuracy, or to a certain quality level. In other cases, a mobile computing device 102 is considered to be capable of performing a specified operation if the computing device 102 can perform the operation at all, without regard to a performance level.

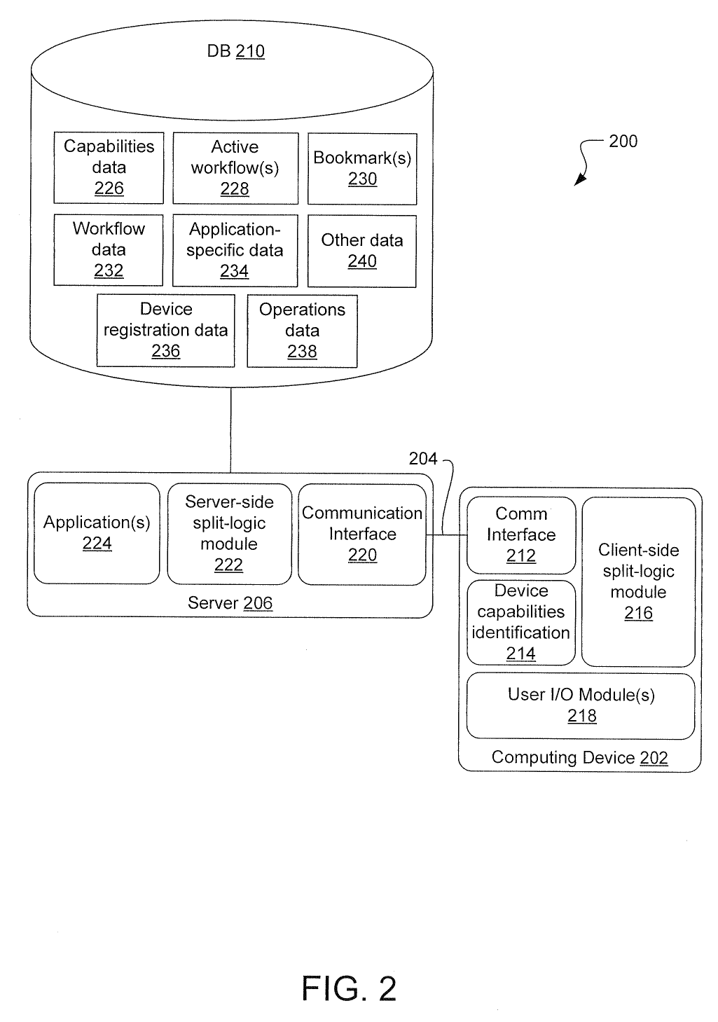

Various embodiments provide for the mobile computing device 102 to perform only the operation(s) that the mobile computing device 102 is determined to be capable of performing or facilitating in association with a workflow, and the server 106 performing any other operation(s) that the mobile computing device 102 is determined incapable of performing. In this regard, a subset of operations within a workflow is identified as being “performable” (i.e., capable of being performed or facilitated) by the mobile computing device 102. Of course the performable subset of operations may include all the operations in a workflow (e.g., in cases involving highly capable mobile computing devices 102), or none of the operations in the workflow. Any operations that are not performable by the mobile computing device 102 may also be identified in some manner, and are typically performed or facilitated by the server 106. Exemplary embodiments of the server 106, database 110, and a mobile computing device 102 are discussed in detail below, with reference to an exemplary functional module diagram shown in FIG. 2.

FIG. 2 illustrates an exemplary system 200, including functional modules for carrying out split-logic determination in accordance with one embodiment. In general, a client computing device 202 is in operable communication with a server computer 206 via communication channel 204 to exchange information related to workflows. In some embodiments, the computing device 202 is a remote computing device and the server computer 206 is a central computing device potentially in communication with numerous remote devices.

Generally, the computing device 202 contacts the server 206 prior to, or during, performance of a workflow. Contacting the server 206 may be automatic, or contacting the server 206 may be initiated by the user of the computing device 202. After the server 206 is contacted, the server 206 sends workflow data to the computing device 202. The workflow data that is sent may include workflow definitions or rules, one or more workflow operations (or references to operations), or other data associated with a workflow. For example, the server 206 may send the computing device 202 one or more indices into a workflow, which indicate which part(s) of the workflow the computing device 202 is to perform or where the computing device 202 is to start or stop performance of operations in the workflow. Based on the workflow data that it receives, the computing device 202 performs operations that the computing device 202 is determined to be capable of performing in association with the workflow.

In some embodiments, the computing device 202 and the server computer 206 interact to determine which operations associated with a workflow, if any, the computing device 202 is capable of performing. Any operations that the computing device 202 is incapable of performing or facilitating are performed or facilitated by the server 206. Accordingly, the computing device 202 and the server 206 split workflow data processing between the computing device 202 and the server 206, based on the capabilities associated with the computing device 202.

In this regard, one embodiment of the computing device 202 includes data and/or one or more functional modules that facilitate determination of how to split workflow data processing between the computing device 202 and the server 206. By way of example, the computing device 202 can include a communication interface 212, a device capabilities identification module 214, a client-side split logic module 216, and user input/output (I/O) module(s) 218. Of course, some computing devices may not include all these modules, while other computing devices may include additional modules not shown in the computing device 202 of FIG. 2. For example, a black box may not include a client-side split logic module 216 or user I/O module(s) 218, whereas a PDA may include additional client-side application programs (not shown).

In the particular embodiment of a black-box, if the remote device fails to make a sensible negotiation regarding a bookmark for the workflow transfer, the host/server will make the decision the device is “dumb” (i.e., has only a minimal set of capabilities) and will rely on the server to maintain the entire execution of the workflow. In the instantiation, the remote computing device will trigger the action to fire, but not be relied upon to process any of the workflow rules or alerts that pertain the result of the trigger.

Turning to the server 206, the illustrated embodiment of the server 206 is coupled to memory, such as a database 210, which includes various data for use by the server 206 and/or the computing device 202 to perform split-logic determination and associated operations. The server 206 generally includes a communication interface 220, a server-side split logic module 222, and application(s) 224. The database 210 includes a number of datasets, including, but not limited to, capabilities data 226, active workflow(s) 228, bookmark(s) 230, workflow data 332, application-specific data 234, device registration data 236, operations data 238, and/or other data 240.

The capabilities data 226 stores device capabilities in association with device types or device identifiers. The active workflow(s) 228 stores identifiers for one or more workflows that are currently or will be in progress. The workflow data 332 stores identifiers for workflows along with their associated operations (or operation IDs). The application-specific data 234 is a logical set of applications and associated data that is used by the server 206 to carry out workflow operations or non-workflow operations. The device registration data 236 stores device identifiers in association with information about the identified devices, such as, but not limited to, device type. The operations data 238 stores workflow operations (or operation IDs) in association with capabilities that are required in order to perform the operations. Other data 240 is any other data that may be necessary or useful to perform workflow operations or split-logic determination.

In one embodiment the various datasets stored in the database 210 are stored in a relational manner. For example, each of the job active workflow(s) 228 may be associated with one or more bookmark(s) 230 and/or workflow data 232. The modules and data illustrated in FIG. 2 are for illustrative purposes only. As such, they are not intended to limit the scope of the invention. As discussed above, the computing device 202 may have more, fewer, or other modules than are shown in FIG. 2. Likewise, the server 206 may have more, fewer, or other modules than those that are shown in FIG. 2, and the database 210 may have more, fewer, or other datasets than those that are shown. For example, the server 206 may include a web server for serving web-pages to web-enabled computing devices. Importantly, the modules and datasets may be combined, broken out, or rearranged in any manner without departing from the scope of the invention.

In an exemplary scenario, the computing device 202 contacts the server 206 via the client communication interface 212 and server communication interface 220. For example, when a field worker begins a job, the computing device 202 may contact the server 206. The server 206 identifies the computing device 202 and/or the user of the device 202 based on a device/user identifier that is transmitted to the server 206. The server 206 then determines a capabilities set associated with the computing device 202. Capabilities associated with the computing device 202 can be determined in a number of ways, depending on the embodiment.

In one embodiment, the registration data 236 is searched for the device or user identifier that is transmitted to the server 206. For example, in some embodiments, the computing device 202 may have registered with the server 206 prior to contacting the server 206. The registration data 236 may include the capabilities of each registered device, in which case the server 206 can find capabilities information for computer device 202 in the registration data 236. Alternatively, the registration data 236 may include a device identifier that can be used to determine the type of computing device 202. In this case, the capabilities data 238 may be organized according to device type, whereby the server 206 can determine the capabilities of the computing device 202 using the device type information from the registration data 236 and searching the capabilities data 226 for the device type. For example, if the computing device 202 had previously registered with the server 206, the server 206 can determine the capabilities of the computing device 202 by looking up the device identifier in the registration data 236 to determine the device type, and then looking up the device type capabilities in the capabilities data 226.

In some embodiments the computing device 202 transmits capabilities identification information to the server 206. Capabilities identification information is any information that the server 206 can use to determine capabilities associated with the computing device 202. For example, and without limitation, capabilities identification information may be device type, device identifier, device components (hardware and software) or device capabilities themselves. Capabilities identification information is discussed in further detail below.

Some embodiments and/or under some circumstances, the computer device 202 may need to transmit its capabilities to the server 206. For example, in some cases the computing device 202 has not registered prior to contacting the server 206. As another example, there may be cases where capabilities data 238 has not been pre-provisioned with capabilities of the particular type of computing device 202. In these and other situations, the device capabilities module 214 is operable to provide the capabilities of the computing device 202. The device capabilities module 214 may have a list of capabilities stored in memory. For example, the device capabilities may be pre-stored in a file of the device capabilities module 214. Alternatively, or in addition, the device capabilities module 214 may have functionality to dynamically determine the capabilities, or changes to the capabilities.

The capabilities information provided by the device capabilities module 214 identifies the capabilities of the computing device 202. The capabilities identification data can be include of, without limitation, one or more of the device type, device components (hardware and software), and/or the capabilities themselves. The capabilities identification data can be in any format suitable for the particular implementation, such as, but not limited to, ASCII text, encrypted text, or files of proprietary format, and application-specific format, or a standard publicly available format. The device capabilities module 214 is operable to cause the capabilities identification information to be transmitted to the server 206 via the client communication interface 212. The server 206 is operable to receive and analyze the capabilities identification data.

In an alternative embodiment, capabilities information associated with a number of computing devices is pre-provisioned or deployed onto the capabilities data 226. In these embodiments, the capabilities data 226 may be pre-provisioned from another source, such as a mobile service provider home office 108 (FIG. 1). For example, the mobile service provider home office 108 may obtain the sets of capabilities of all the devices of its field work force and send the capabilities information to the server 206 or directly to the data store 210. Each set of capabilities information may be sent in association with a device identifier and/or a device type. The capabilities information may then be stored on the database 210 in association with the device identifier (identifying the particular device) and/or the device type. Later, when the server 206 receives a device identifier from the computing device 202, the server 206 can determine the device type and then look up the associated capabilities information; or, the server 206 can look up the computing device's 202 capabilities directly using the device identifier, depending on the organization of the device capabilities data 226.

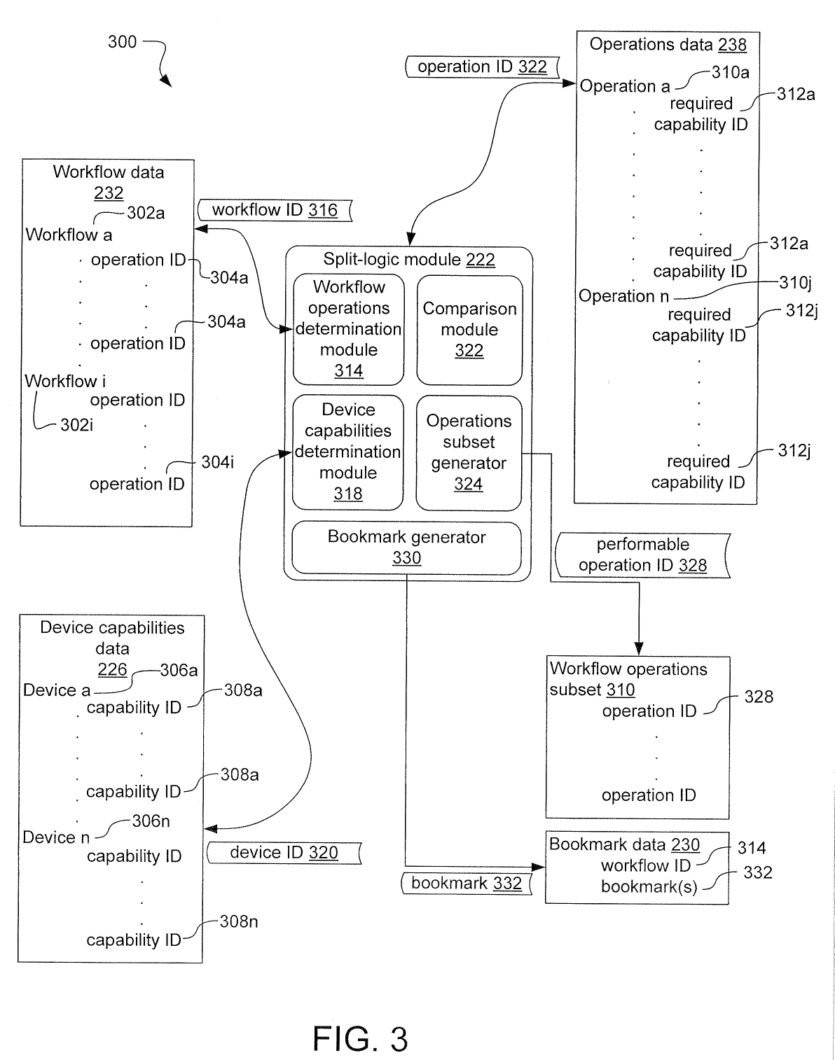

Server-side split logic module 222 is operable to determine computing device 202 capabilities using a device type or device identifier. In one embodiment, the split-logic module 222 uses device type data in the capabilities identification data to look up capabilities in the capabilities data 226. Alternatively, the server-side split-logic module 222 may read the capabilities directly from capabilities identification data sent from the computing device 202, if the capabilities are specified in capabilities identification data. A particular embodiment of the server-side split logic module 222 is shown in FIG. 3 and discussed further below.

In some embodiments the computing device 202 may not be operable to transmit device capabilities identification data and/or the server 206 is unable to determine the device's 202 capabilities. In these embodiments, the server-side split logic module 222 assumes a specified set of capabilities associated with the computing device 202. In some embodiments, the assumed specified set of capabilities is a minimal set of capabilities, including a minimal set of interface characteristics and processing ability.

The server-side split-logic module 222 is further operable to determine the workflow being performed at the computing device 202. The workflow may be determined in any number of ways. By way of example, but without limitation, the computing device 202 may send a workflow identifier to the server 202, or the split-logic module 222 may use data from a dispatch office and/or in the database 210 that identifies the workflow associated with the computing device 202 or the field worker. For example, the worker may have one or more jobs that correspond to workflows that need to be performed on a given day, and these workflows can be identified in a set of active workflows 228. The server-side split-logic module 222 can search for the workflow based on an identifier transmitted from the remote computing device 202.

Using the determined capabilities data and workflow, the server-side split-logic module 222 identifies a subset of operations and/or actions (or other data) to be performed by the computing device 202 in the workflow being performed. In one embodiment, a number of workflow IDs are stored with the associated operations and/or actions in a set of workflow data 232. If one or more workflow operations are identified that are performable with the capabilities associated with the computing device 202, a set of workflow data is transmitted to the computing device 202. The workflow data that is sent to the computing device typically includes the one or more identified operations, or references to the operations, to be performed or facilitated by the computing device 202. The data sent to the computing device 202 can also include workflow rules, action information, and action rules.

In some embodiments, all the workflow data (e.g., operations, actions, rules, etc.) are transmitted to the computing device 202, with one or more indicators that indicate which of the operations are to be performed by the computing device 202. These indicators, referred to as split-logic indicators, logically divide a set of workflow operations into parts that are to be performed by the computing device 202 and parts that are to be performed by the server 206.

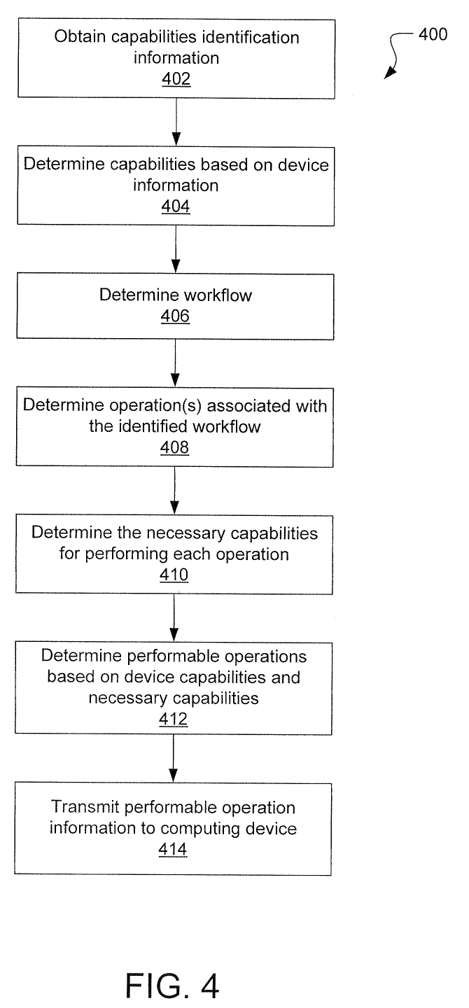

In various embodiments, the client-side split-logic module 216 and/or the server-side split logic module 222 uses the device capabilities data to determine what operations, if any, the computing device 202 can perform in the identified workflow. The client-side split-logic module 216 and/or the server-side split-logic module 222 may generate split-logic indicators or bookmarks, or some other type of reference, which indicates a logical point or points in the workflow operations that the computing device 202 can or cannot perform. These bookmarks 230 may be stored in the database 210, for example in a set of bookmarks 230. As is discussed further below, with respect to a particular split-logic scenario shown in FIG. 4, the bookmark(s) 230 can be used during the workflow to pass data processing from the client computing device 202 to the server 206 or vice versa.

In one embodiment, after the split-logic module 216 determines which operations are to be performed by the computing device 202 and notifies the computing device 202, the server-side split-logic module 222 adds an entry to the active workflow(s) 228, indicating that a new workflow has begun. The entries in the active workflow(s) 228 can be used to track workflows in process. During the performance of workflow operations, the server 206 may launch one or more application programs. For example applications 224 may include billing applications, time entry applications, scheduling applications, inventory applications, routing/mapping applications, spreadsheet, calculator, word processing, or others. Application-specific data 234 includes data that is used by application(s) 224 that might execute on the server 206, for example, in the course of a workflow.

FIG. 3 illustrates a split-logic determination scheme 300 in accordance with one embodiment. The split-logic module 222 interacts with a number of sets of data to determine capabilities associated with a computing device and a subset of workflow data, including operations, to be performed by the computing device. In this embodiment, the split-logic module 222 interacts with workflow data 232, device capabilities data 226, and operations data 238 to generate one or more of a workflow operations subset 326 and bookmark data 332.

In the illustrated embodiment, workflow data 232 includes multiple workflow identifiers, such as workflow a 302a through workflow i 302i. Each workflow ID 302 is stored in association with workflow data, such as operation IDs. Workflows may generally include more parts, such as actions, rules, events, or others. For example, typically a workflow includes one or more actions, and each action includes one or more operations. For ease of illustration, only the workflow operation IDs are shown in FIG. 3.

The device capabilities data 226 includes multiple device type identifiers, such as device a 306a through device n 306n. Each device type ID 306 is stored in association with one or more capability IDs 308. Operations data 238 includes multiple operation IDs, such as operation a 310a through operation j 310j. Each operation ID 310 is stored in association with one or more required capability IDs 312.

A workflow operations determination module 314 uses a specified workflow ID 316 to determine operations that make up a specified workflow. For example a remote computing device may specify the workflow ID in a transmission that the split-logic module 222 receives. The workflow operations determination module 314 searches the workflow data 232 with the workflow ID 314.

A device capabilities determination module 318 uses a specified device ID 320 to determine capabilities associated with the remote computing device. The device ID may be specified in a transmission from the remote computing device. The device capabilities determination module 318 searches for the specified device ID 320 in the device capabilities data 226. The device ID cannot be found in the device capabilities data 226, the device capabilities determination module 318 associates the remote computing device with a default set of capabilities, such as a predetermined minimal set of capabilities.

A comparison module 322 compares capabilities that are required to perform operations in the workflow of workflow ID 314 with capabilities associated with the remote computing device involved in the identified workflow. In one embodiment, the comparison module 322 uses operation IDs 304 included in the workflow ID 314, found in the workflow data 232 to determine capabilities required to perform the operations of the workflow identified by workflow ID 314. For example, assume that workflow i 302i corresponds to workflow ID 314. Further assume that operation ID 304i corresponds to operation ID 322. In this case, comparison module 322 searches the operations data 238 for operation ID 322. When the operation ID 322 is found in the operation data 238, the required capabilities 312 associated with operation ID 322 are read and compared to the device capability IDs 308 determined by the device capabilities determination module 318.

The operations subset generator 324 uses the information derived from the comparison module 322 to generate a subset 326 of one or more performable operation IDs 328 associated with operations that the remote computing device is to perform. In one embodiment, the operations subset generator determines the device capabilities 308 that match the required capabilities 312 as determined by the comparison module 322. If all required capabilities match for a given operation ID 322, then the operation ID 322 is included in the workflow operations subset 326.

As discussed above, sets of one or more operations 328 of the workflow may make up an action. In some embodiments, any operations that are performable by the remote computing device (and in the identified workflow) are included in the workflow operation subset 326. As such, the remote computing device may perform only a fractional part of an action.

In other embodiments, only entire actions (all operations of an action) are included in the workflow operations subset 326. In these embodiments, fractional portions of actions are not included in the subset 326. As such, the remote computing device performs only entire actions of the workflow.

A bookmark generator 330 may generate one or more split-logic indicators 332 (e.g., bookmarks) that reference logical points in the identified workflow where operation execution is to be transferred between the remote computing device to the server. The bookmarks 332 are stored in bookmark data 230. The bookmarks 332 may be stored in association with the workflow ID 316. The bookmarks 332 may also be stored in association with a device identifier identifying the remote computing device involved in the identified workflow.

In other embodiments, some or all of the operations shown and described with respect to the scheme of FIG. 3 can be carried out by the remote computing device. For example, client-side split logic module 216 (FIG. 2) can receive device capabilities from the device capabilities identification module 214 and compare the device capabilities to a set of capabilities (not shown) stored in memory of the client device 202 to determine operations of the workflow to be performed.

### Exemplary Operations

Referring to FIG. 4, a flowchart is presented that illustrates a split-logic determination algorithm 400. The split-logic determination algorithm 400 may be carried out by a central computer or server, such as server 206 (FIG. 2). The split-logic algorithm 400 typically occurs in response to, or during a workflow, being performed or facilitated by a computing device, such as a mobile communication device. The split-logic determination algorithm 400 generally starts with obtaining operation 402, wherein the server obtains capabilities identification information related to a computing device. By way of example and not limitation, this information may include the mobile communication device ID, a configuration file from the mobile communication device detailing its capabilities, communication device type, or the workflow identification. The capabilities identification information may be sent to the server by the computing device.

Based at least in part on the information obtained in obtaining operation 402, a determining operation 404 determines capabilities associated with the computing device. For example, in one embodiment the computing device sends the server its capabilities. In another embodiment, the computing device sends the server its device ID, which the server uses to search for capabilities in a device registration data store (e.g., device registration data 236, FIG. 2). The determining operation 404 may also involve using a device type associated with the computing device to look up capabilities associated with the device type.

In another determining operation 406, a workflow is determined that the computing device is involved in. In one embodiment, a workflow ID is sent to the server computer. Alternatively, the workflow ID can be found in a set of active workflows data (e.g., active workflows 228, FIG. 2) based on computing device ID or user ID. As yet another example, the workflow may be identified by a dispatcher or dispatcher computer transmitting the workflow ID or a pre-scheduled work-list for either the computing device or the user of the computing device.

Another determining operation 408 determines operations associated with the identified workflow. The server may access a workflow database containing a list of all the potential workflows and their corresponding operations. Alternatively, or in addition, actions of the identified workflow may be determined first, and, based on the actions of the workflow, the operations may be determined. The determining operation 408 may also determine any other information related to the identified workflow, such as, without limitation, rules, events, and other data.

Another determining operation 410 determines capabilities that are necessary for each operation determined in the identified workflow (or corresponding actions). In one embodiment, a data store is accessed that contains a list of all potential operations and device capabilities required for the operations to be performed. Each operation may have one or more capabilities required for the operation's performance.

Another determining operation 412 determines operations of the workflow that are to be performed (performable) by the computing device. In one embodiment the necessary capabilities for performance of each operation in the workflow are compared with the capabilities of the computing device. In one embodiment, the server compiles a list of operations that the computing device may carry out. In another embodiment, the server compiles a list of operations that the server must carry out because the mobile computing device is unable to do the data processing. Alternatively, the server may create a workflow operations split-logic indicator (e.g., bookmark or index) that indicates to the relevant workflow and indicates which operations are performed by the computing device and which operations are performed by the server.

In a transmitting operation 414 performable operation information is transmitted to the computing device. The performable operation information may be only the subset of operations in the identified workflow that are to be performed by the computing device. Alternatively, the performable operation information may include all the operations of the identified workflow, with a split-logic indicator. Alternatively, the performable operation information may include a workflow ID with a split-logic indicator.

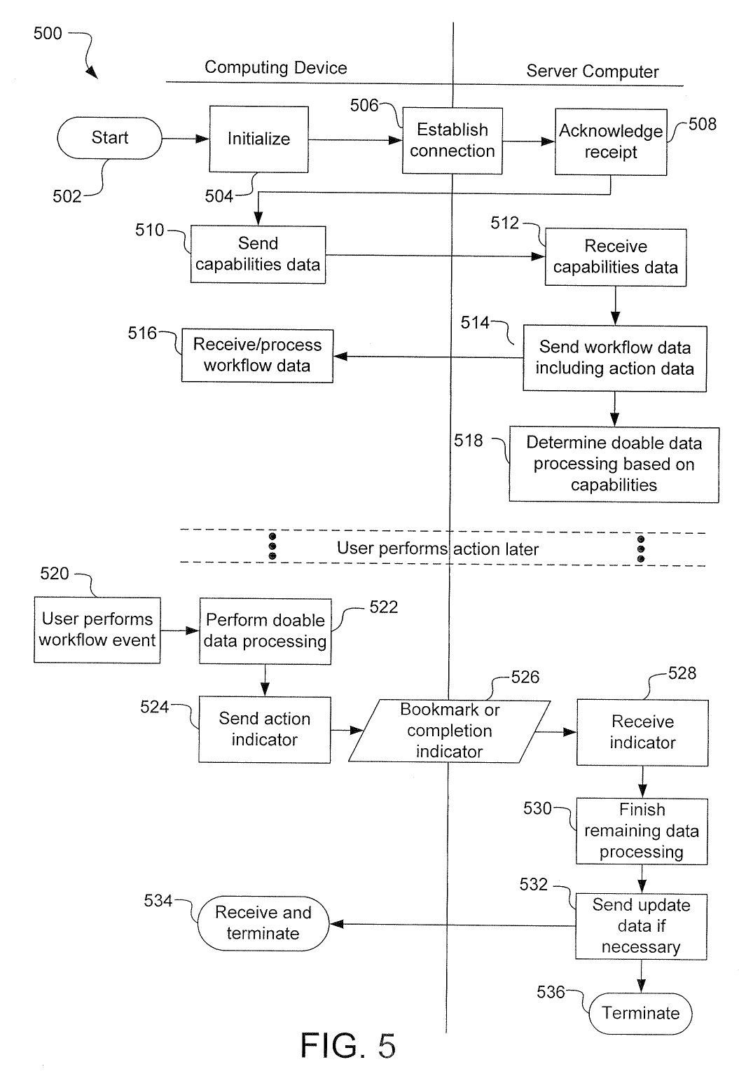

Referring to FIG. 5, a flowchart is presented that illustrates an algorithm 500 having exemplary operations for carrying out split-logic determination in accordance with one embodiment. The algorithm 500 involves a first device, referred to as the remote computing device or just computing device, and a second device, referred to as the server computer, which is a computing device that is accessible by the remote computing device. The algorithm begins at starting operation 502, at which the computing device is activated. An initializing operation 504 powers up the computing device and initializes components in the device.

An establishing operation 506 establishes a connection to a server computer. The establishing operation 506 may occur automatically or be prompted by user input. Depending on the communication protocol, the establishing operation 506 can involve bi-directional communications between the computing device and the server computer, wherein the two devices negotiate a channel. However, such a channel negotiation may not be used in other network/communication protocol environments. In an acknowledging operation 508, the server computer acknowledges receipt of connection data.

In a sending operation 510, the computing device sends capabilities data to the server computer. Capabilities data can be any data that facilitates determination of capabilities of the computing device, including, but not limited to, device type, capabilities, and registration information, or no capabilities data at all, in which case, the server computer chooses a default set of capabilities to attribute to the computing device. In a receiving operation 512, the server computer receives any capabilities data that the computing device sent. Based on the workflow being performed, the server computer then sends workflow data to the computing device in sending operation 514.

At receiving and processing operation 516 the computing device receives the workflow data and processes it. At a determining operation 518, the server computer uses the device capabilities data to determine which workflow data processing (or operations) the computing device is capable of performing. In one embodiment of the determining operation 518, the server computer identifies performable data processing. In other embodiments, the computing device may perform the determination as to performable data processing and indicate to the server computer which data processing the computing device can perform. In yet another embodiment, both the computing device and the server computer might determine the performable data processing separately, or in cooperation.

Later, a workflow event occurs in performing operation 520. The workflow event may be an action or other triggering event carried out by the user of the remote computing device. Based on the event that is performed, the client device performs one or more performable workflow data processing operations corresponding to the event in a performing operation 522. The performing operation 522 may or may not perform all operations in an action of the workflow. For example, the operations performed may comprise a multiple number of actions plus a fraction of another action in the workflow. In other cases, the performable operations may be selected such that only non-fractional multiples of actions are performed by the computing device, whereby data processing will not be transferred back in the midst of performing an action. In a sending operation 524, the computing device sends a data processing transfer indicator, such as a split-logic indicator, bookmark or data processing completion indicator 526 to the server computer.

Upon receipt of the data processing transfer indicator in receiving operation 528, the server computer finishes any remaining data processing in finishing operation 530. In the finishing operation 530, the server uses the data processing transfer indicator from the computing device to locate the workflow data processing, if any, that remain to be performed in association with the workflow event. In some cases, the computing device may need updated data after the data processing is performed. As such, a sending operation 532 sends the updated data to the computing device, if necessary. If the updated data is sent to the computing device, the computing device receives it at receiving and terminating operation 534. The computing device terminates this portion of the workflow processing. Likewise, the server computer terminates this portion of the workflow processing in another terminating operation 536.

The operations shown in FIGS. 4-5 are not limited to the particular order shown. Operations may be performed in different orders, in parallel, or otherwise, where order is not required. In addition, steps included in each operation may be broken out and/or moved into other operations.

### Exemplary Computing Device

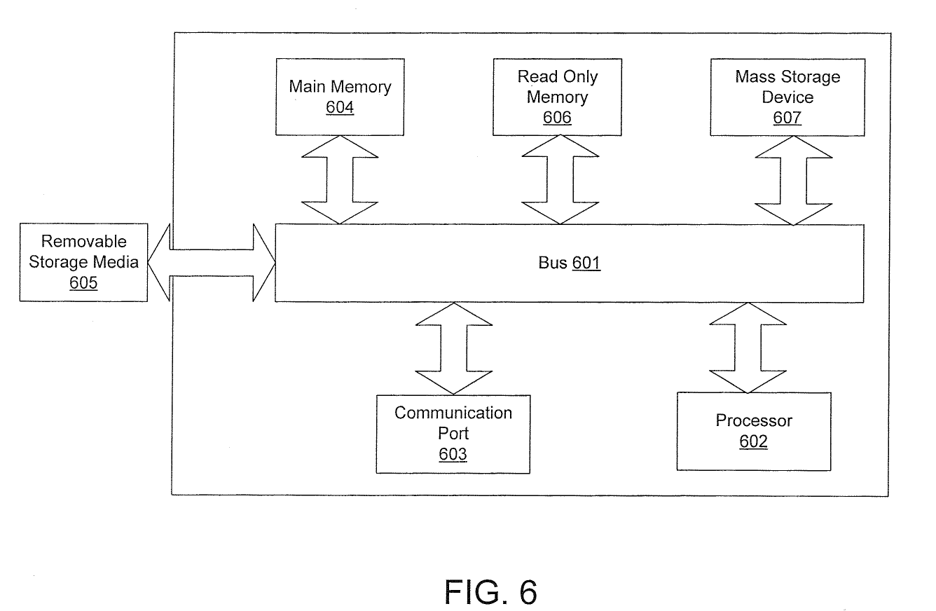

FIG. 6 is a schematic diagram of a computing device 600 upon which an systems and methods for split-logic determination may be implemented. The components computing device 600 are illustrative of components that some mobile computing devices and/or server computers might include. However, any particular computing device may or may not have all the components illustrated. In addition, any given computing device may have more components than those illustrated.

As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 600 includes a bus 601, at least one processor 602, at least one communication port 603, a main memory 604, a removable storage media 605 a read only memory 606, and a mass storage 607. Processor(s) 602 can be any know processor, such as, but not limited to, an Intel® Itanium® or Itanium 2® processor(s), or AMD® Opteron® or Athlon MP® processor(s), or Motorola® lines of processors. Communication port(s) 603 can be any of an RS-232 port for use with a modem based dialup connection, a 10/100 Ethernet port, or a Gigabit port using copper or fiber. Communication port(s) 603 may be chosen depending on a network such a Local Area Network (LAN), Wide Area Network (WAN), or any network to which the computing device 600 connects. The computing device 600 may be in communication with peripheral devices (not shown) such as, but not limited to, printers, speakers, cameras, microphones, or scanners.

Main memory 604 can be Random Access Memory (RAM), or any other dynamic storage device(s) commonly known in the art. Read only memory 606 can be any static storage device(s) such as Programmable Read Only Memory (PROM) chips for storing static information such as instructions for processor 602. Mass storage 607 can be used to store information and instructions. For example, hard disks such as the Adaptec® family of SCSI drives, an optical disc, an array of disks such as RAID, such as the Adaptec family of RAID drives, or any other mass storage devices may be used.

Bus 601 communicatively couples processor(s) 602 with the other memory, storage and communication blocks. Bus 601 can be a PCI/PCI-X, SCSI, or USB based system bus (or other) depending on the storage devices used. Removable storage media 605 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method for performing a workflow using a first computing device in communication with a second computing device, wherein the workflow includes one or more actions, wherein each action includes one or more operations, the method comprising:
determining capabilities associated with the first computing device;
based on the capabilities of the first computing device, determining at least a subset of the one or more operations that the first device can perform;
transmitting to the first computing device at least the subset of the one or more operations that the first device can perform;
performing by the first computing device the subset of the one or more operations; and
performing by the second computing device any remaining operations in the one or more operations not included in the subset.

2. The method as recited in claim 1, further comprising transmitting the capabilities associated with the first computing device to the second computing device.

3. The method as recited in claim 2, wherein transmitting the capabilities associated with the first computing device comprises transmitting the capabilities when the first device powers on.

4. The method as recited in claim 1, wherein determining at least a subset of the one or more operations that the first device can perform is performed by the second computing device.

5. The method as recited in claim 1, wherein the subset of operations that the first device can perform comprises at least one complete action from the one or more actions.

6. The method as recited in claim 1, wherein transmitting at least the subset of the one or more operations that the first device can perform comprises transmitting more operations than are included in the determined subset of operations, and further comprises transmitting a split-logic indicator indicating which operations the first computing device is to perform and which operations the second computing device is to perform.

7. The method as recited in claim 1, wherein determining capabilities associated with the first computing device comprises determining the device capabilities based on a device type associated with the first computing device.

8. The method as recited in claim 7, further comprising registering the first computing device with a device registration server, wherein registering the first computing device comprises registering the device type, and wherein determining capabilities associated with the first computing device further comprises:
reading the device type from the device registration server; and
reading capabilities of the first computing device from a memory storing a plurality of device types, each device type stored in association with device capabilities.

9. The method as recited in claim 7, further comprising transmitting the device type from the first computing device to the second computing device.

10. The method as recited in claim 1, wherein determining capabilities associated with the first computing device comprises defaulting to a minimal set of device capabilities.

11. The method as recited in claim 1, wherein transmitting at least the subset of operations that the first computing device can perform comprises transmitting only the subset of operations that the first computing device can perform, and wherein the method further comprises:
performing by the first computing device the subset of operations transmitted to the first computing device;
notifying the second computing device that the first computing device has completed performing the subset of operations; and
performing by the second computing device one or more remaining operations in the workflow that are not included in the subset of operations that the first computing device performed.

12. A system for use in performing a workflow, the workflow including one or more operations, the system comprising:
a remote computer operable to transmit capabilities identification information useable to determine capabilities associated with the remote computer;
a central computer operable to receive the capabilities identification information and use the capabilities identification information to determine capabilities associated with the remote computer, the central computer further operable to determine a subset of the one or more operations to be performed by the remote computer during performance of the workflow, based on the determined capabilities associated with the remote computer, the central computer further operable to perform any operations in the workflow that are not in the determined subset of operations.

13. The system as recited in claim 12, further comprising a data store in operable communication with the central computer, the data store storing capabilities information related to a plurality of remote computers, wherein the central computer is further operable to look up capabilities associated with the remote computer.

14. The system as recited in claim 13, wherein the capabilities information in the data store comprises a device matrix searchable by one or more of a device type or a device identifier.

15. The system as recited in claim 13, the data store further storing device registration data related to a plurality of remote computers, and wherein the remote device is operable to register with the data store.

16. The system as recited in claim 12, wherein the central computer comprises:
a split-logic determination module operable to map operations to remote device capabilities that are required to perform the operations; and
a communication interface operable to transmit to the remote computer at least the subset of operations to be performed by the remote computer.

17. The system as recited in claim 16, wherein the communication interface transmits only the subset of operations to the remote computer, and wherein the remote computer is further operable to notify the central computer when the remote computer is completed performing the subset of operations.

18. The system as recited in claim 16, wherein the split-logic determination module is operable to generate a split-logic indicator indicating a logical point in the one or more operations of the workflow that divides the subset of operations to be performed by the remote computer from another subset of operations to be performed by the central computer, and wherein the communication interface transmits all of the one or more operations in the workflow to the remote computer.

19. The system as recited in claim 18, wherein the remote computer is operable to notify the central computer when the remote computer has completed performing the subset of operations up to the split-logic indicator.

20. The system as recited in claim 12, wherein the central computer associates a minimal set of capabilities with the remote device.
